(19) United States
(12) Patent Application Publication
(10) Pub. No.: US 2024/0267340 A1
(43) Pub. Date: Aug. 8, 2024

(54) TIME ORDERED SWITCHING

(71) Applicant: Intel Corporation, Santa Clara, CA (US)

(72) Inventors: Anil VASUDEVAN, Portland, OR (US); Roberto PENARANDA CEBRIAN, Santa Clara, CA (US); Md Ashiqur RAHMAN, Phoenix, AZ (US); Pedro YEBENES SEGURA, San Jose, CA (US); Allister ALEMANIA, North Plains, OR (US)

(21) Appl. No.: 18/618,254

(22) Filed: Mar. 27, 2024

(51) Int. Cl. H04L 47/70

(52) U.S. Cl. CPC H04L 47/826

(57) ABSTRACT

Examples described herein relate to a network interface device that includes an interface to a port; and a circuitry. The circuitry can be configured to: receive a first packet that comprises a time stamp associated with a prior or originating transmission of the first packet by a transmitter network interface device; enqueue an entry for the first packet in a queue; and dequeue the entry based at least in part on the time stamp.

### BACKGROUND

A datacenter can include multiple computing platforms communicatively coupled by network interface devices and switches. Excessive traffic in the datacenter network can cause congestion and packet drops, which leads to slower packet traffic. To avoid congested network device queues, a network interface device can transmit packets of a flow through different egress ports and different paths using a technique called packet spraying. However, packet spraying can lead to out-of-order packet receipt, which can incur packet re-ordering and lead to delays in providing packets to a receiver.

### BRIEF DESCRIPTION OF THE DRAWINGS

FIG. 1 depicts an example system.

FIG. 2 depicts an example system and operation.

FIGS. 3A and 3B illustrate examples of egress ordering from different ingress queues.

FIG. 4 depicts an example process.

FIG. 5 depicts an example network interface device.

FIGS. 6A-6C depict example switches.

FIG. 7 depicts an example system.

### DETAILED DESCRIPTION

At least to attempt to reduce out-of-order packet delivery to an endpoint network interface device, various examples can time synchronize network interface devices that transmit packets to a switch and configure the switch to egress packets in time stamp order, from oldest time stamp to newest time stamp. An endpoint sender or switch can insert a timestamp into a packet transmit prior to transmission of the packet, to indicate packet transmission time. The transmitter end stations and the switches can participate in time synchronization, as described herein. When the packet arrives (ingresses) at the switch, the switch can assign the packet into an output queue according to time order so that packets that egress the switch are time ordered. The switch can perform timestamp-based load balancing of packets received by different ingress ports and associated with different queues. The switch can perform per-packet egress port scheduling based on time stamp values across one or more flows instead of, or in addition to, flow-based scheduling.

A switch egressing traffic by time stamp ordering can reduce a likelihood of out-of-order arrival of packets at a receiver. In some cases, incast scenarios (e.g., all-to-one or many-to-one traffic patterns) can be mitigated, which can lead to lower tail latencies and faster receipt of packets of a flow. Tail latency is a tail of the packet segment fetch latency probability distribution (also known as latency profile) of the switch fabric. Tail latency refers to the worst-case latencies seen at very low probability.

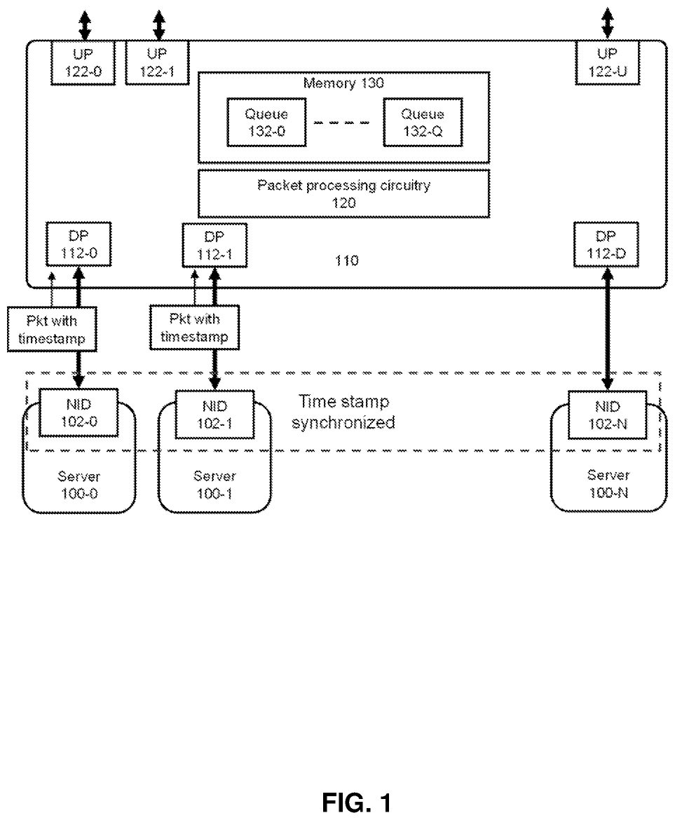

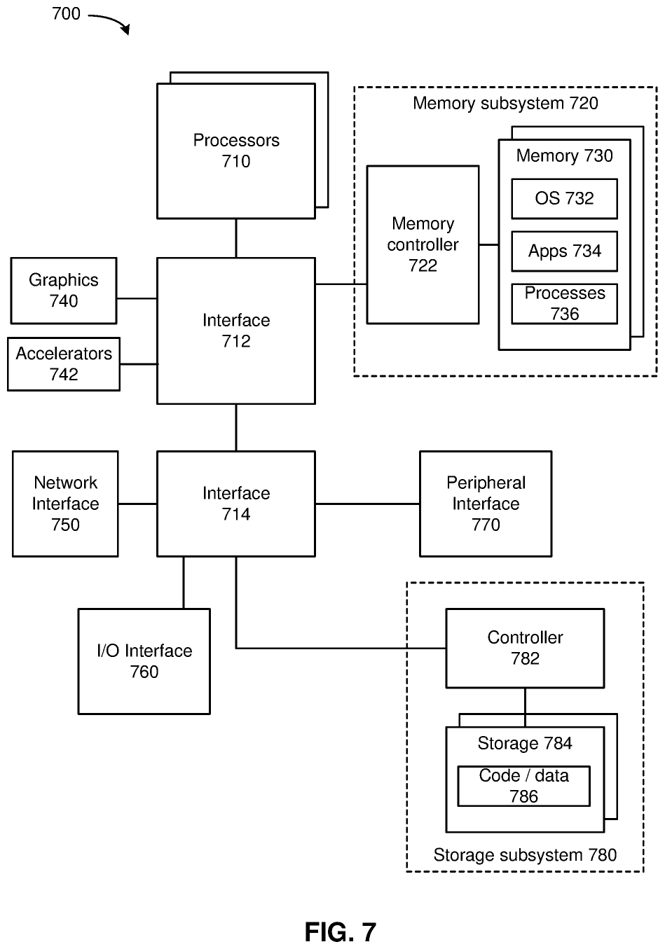

FIG. 1 illustrates an example switch. Servers 100-0 to 100-N, where N is an integer, can configure one or more of respective network interface devices 102-0 to 102-N to insert a transmit time stamp into packets prior to transmission of the packets to switch 110 or disable one or more of respective network interface devices 102-0 to 102-N from inserting a transmit time stamp into packets prior to transmission of packets to switch 110. Various examples of servers 100-0 to 100-N are described at least with respect to FIG. 7.

In some examples, switch 110 can include one or more of: a network interface controller (NIC), a remote direct memory access (RDMA)-enabled NIC, SmartNIC, router, switch, virtual switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized Radio Access Networks (vRANs), cryptographic operations, compression/decompression, and so forth). A virtual switch can provide virtual machine-to-virtual machine communications for virtual machines in a same server or among different servers.

In some examples, network interface devices 102-0 to 102-N can be time synchronized based on time synchronization technologies including Institute of Electrical and Electronics Engineers (IEEE) 1588 Precision Time Protocol (PTP), Peripheral Component Interconnect Express (PCIe) Precision Time Measurement (PTM), a global positioning system (GPS) signal, satellite (e.g., Global Navigation Satellite Systems (GNSS)), or other technologies.

In some examples, media access control (MAC) processors and/or physical layer interfaces (PHYs) of network interface devices 102-0 to 102-N can be configured to insert a transmit time stamp into a packet prior to transmission to switch 110. A network interface device can insert a time stamp into a header field of a packet. Timestamp fields can be inserted into network and/or transport protocol headers that are transmitted end-to-end such as an Internet Protocol (IP) header field, Ethernet header field, or other header fields.

Network interface devices 102-0 to 102-N can transmit packets of a same or different flow across different paths using one or more egress ports. For example, network interface devices 102-0 to 102-N can transmit packets based on multipath packet transmission technologies including Internet Engineering Task Force (IETF) Request for Comments (RFC) 6824, “TCP Extensions for Multipath Operation with Multiple Addresses” (2020), or others.

Switch 110 can be configured as a top of rack (TOR) switch, end of row (EOR) switch, or middle of row (MOR) switch. Switch 110 can be positioned as a leaf or spine switch. Switch 110 can receive packets from network interface devices 102-0 to 102-N by one or more downstream ports (DPs) 112-0 to 112-D, where D is an integer. Switch 110 can store received packets into queues 132-0 to 132-Q, where Q is an integer. For example, different queues among queues 132-0 to 132-Q can be associated with different DP so that a packets from a particular DP are stored into a particular queue.

At ingress, packet processing circuitry 120 can separate received packets with time stamp values from packets with no time stamp values so that a queue of queues 132-0 to 132-Q does not store packets with time stamps and packets with no time stamps. However, packet processing circuitry 120 can store packets with time stamp values and packets with no time stamp values into a queue of queues 132-0 to 132-Q so that the queue of queues 132-0 to 132-Q stores packets with time stamps and packets with no time stamps.

A packet can refer to various formatted collections of bits that may be sent across a network, such as Ethernet frames, Internet Protocol (IP) packets, Transmission Control Protocol (TCP) segments, User Datagram Protocol (UDP) datagrams, Real-time Transport Protocol (RTP) segments, and so forth. A packet can be associated with a flow. A flow can be one or more packets transmitted between two endpoints. A flow can be identified by a set of defined tuples, such as two tuples that identify the endpoints (e.g., source and destination addresses). For some services, flows can be identified at a finer granularity by using five or more tuples (e.g., source address, destination address, IP protocol, transport layer source port, and destination port).

Based on arrival of a packet at a DP, circuitry of switch 110 can enqueue the packet into a per-ingress port queue, so that packets from a DP are time ordered for that port. In some cases, packets from a DP are stored in a queue of a particular priority level. For example, one or more of queues 132-0 to 132-Q can store packets from a particular DP and for one or more priority levels.

An orchestrator or data center administrator can configure packet processing circuitry 120 to egress packets from queues 132-0 to 132-Q by time stamp order to prioritize egress of an oldest time stamp value associated with packets in queues 132-0 to 132-Q. Packet processing circuitry 120 can egress packets according to time stamp order for traffic flowing from servers 100-0 to 100-N via one or more of ports UP 122-0 to 122-U, where U is an integer, upstream to a spine layer or switch fabric. Similarly, for received downstream packets, packet processing circuitry 120 can egress packets according to time stamp order for traffic flowing to one or more of network interface devices 110-0 to 110-N via one or more of ports DP 112-0 to 112-D from fabric to servers direction.

For example, to determine which packet to egress from queues 132-0 to 132-Q from a port among UP 122-0 to 122-U, packet processing circuitry 120 can select an oldest packet from per port ingress queues 132-0 to 132-Q. In some cases, packets arriving on a switch port DP can be time ordered within that port because such packets were transmitted according to time ordering.

Packet processing pipeline 120 can egress packets based on time stamp order and on a priority basis so that higher priority level packets are egressed according to time stamp order before lower priority packets according to time stamp order. Packet processing pipeline 120 can egress packets based on time stamp order unless another packet with newer time stamp has a higher priority level. Packet processing pipeline 120 can egress packets so that a higher priority packet among packets with same time stamp values or time stamp values within a configured time stamp value difference are egressed prior to lower priority packets. Packet processing pipeline 120 can egress packets having the same timestamp values or timestamp values within a range simultaneously from multiple independent ports. For example, for a packet P1 with a timestamp value of T2 and a high priority level and a packet P2 with a timestamp value of T1 and a low priority level, where T1 is older than T2, packet processing pipeline 120 can egress packet P1 prior to P2 if T2 is within a configured timestamp difference from T1.

Where upstream ports UP of switch 110 are connected to another switch, at a fabric, ingress packets can be time ordered as well. To determine an oldest packet, packet processing circuitry 120 can select an oldest time stamp packet (e.g., lower time stamp value) at the head of one or more ingress queue associated with a switch port. Where a number of queues or entries in a queue is at or more than a configured number (e.g., 64 or 128), packet processing circuitry 120 can select an oldest time stamp from the configured number of queues and/or entries in a queue even if the oldest time stamp is not head of queue. However, packet processing circuitry 120 can schedule packets for egress based on receipt of the packets, instead of waiting to schedule egress based on reaching a number of entries in a queue.

Note that time stamp values can wrap around (reset to zero) and packet processing circuitry 120 can track the last timestamp received from an ingress port, and if a new timestamp value received is lower than the last one received, packet processing circuitry 120 can detect timestamp wrap around and take into account timestamp wrap around to determine which timestamp is the oldest to schedule a packet for egress. For example, based on detection of timestamp wrap around, packet processing circuitry 120 can select a packet with a higher value time stamp as having an older time stamp and schedule such selected packet for egress.

Some examples can increase utilization of a network by lowering congestion from packet spraying. Some examples can reduce congestion caused by flow based egress port choices (e.g., Equal-Cost Multi-Path routing (ECMP) hashing).

For example, switch metrics can be inserted into a packet and transmitted with the packet or sent to the endpoint transmitter or a leaf switch. Switch metrics can include time spent by a packet in a switch hop and such switch metrics can be used to choose a different network path for packets to reduce time spent by packets in a switch hop. In some examples, switch metrics can be conveyed in metadata of in-band telemetry schemes such as those described in: “In-band Network Telemetry (INT) Dataplane Specification, v2.0,” P4.org Applications Working Group (February 2020); IETF draft-lapukhov-dataplane-probe-01, “Data-plane probe for in-band telemetry collection” (2016); and IETF draft-ietf-ippm-ioam-data-09, “In-situ Operations, Administration, and Maintenance (IOAM)” (Mar. 8, 2020). In-situ Operations, Administration, and Maintenance (IOAM) records operational and telemetry information in the packet while the packet traverses a path between two points in the network. IOAM discusses the data fields and associated data types for in-situ OAM. In-situ OAM data fields can be encapsulated into a variety of protocols such as NSH, Segment Routing, Geneve, IPv6 (via extension header), or IPv4.

In some examples, where a time gap between received time stamp values is larger than a configured value, packet processing circuitry 120 can indicate to an endpoint that re-ordering is to take place and/or proactively send a negative acknowledgement (NACK) to a sender to indicate packet drop and cause re-transmission of a packet having such time stamp gap.

In some examples, a sort layer in a network interface device or a host software can perform time stamp based egress of packets.

Packet processing circuitry 120 can select from among UP 122-0 to 122-U to egress packets in time stamp order from queues 132-0 to 132-Q based on one or more of: lowest load, round robin, or weighted round robin. Packet processing circuitry 120 can prioritize egress of packets with time stamps over packets with no time stamps. For example, packets with no time stamps can be egressed at best efforts. Packet processing circuitry 120 can schedule simultaneous egress of packets with a same timestamp value across multiple independent ports.

In some cases, where received packets P1 and P2 are associated with a same flow, received in a same ingress port, and P1 is a larger byte size than P2, P2 can arrive at a destination sooner than P1 if smaller packets traverse the network to a destination faster and P1 and P2 can arrive out-of-order at a destination. In some cases, packet processing circuitry 120 can schedule egress of P2 to egress on a different egress port than that of P1, after P1 has completed egress, to reduce likelihood of out of order arrival of P1 and P2 at an endpoint.

For an all-to-all pattern, the starting point for initiating all-to-all communication could have a time offset map that accounts for the offsets in timed transmission from the start of an all-to-all communication task on a given node. For example, if there are 4 nodes communicating, N1, N2, N3, and N4, this map could specify that if time stamp t is the start time of an communication at a node, then the transmit start time from N1 to N2, N3 to N2 and N4 to N2 are delayed with respect to each other such that their arrival at N2 is staggered. This can reduce the probability of exceeding queue thresholds that can lead to incast. A Linux® Earliest Txtime First (ETF) capability can be utilized to set these times.

In some examples, switch 110 or an endpoint receiver network interface device can perform packet re-ordering based on transmit time stamps. Re-ordering methods can be applied at an end station (e.g., Amazon Scalable Reliable Datagram (SRD), Data Plane Development Kit (DPDK) reordering technologies, or others).

In some examples, packet processing circuitry 120 can be implemented as one or more of a field programmable gate array (FPGA), an accelerator, application specific integrated circuit (ASIC), processor, or other circuitry.

Switch 110 can be implemented as a switch chip (e.g., switch system on chip (SoC), one or more tiles, a multi-chip module, and/or a package). In some examples, a switch can be implemented using a physical package that includes one or more die or tiles. In some examples, a physical package can include discrete dies and tiles connected by mesh or other connectivity as well as an interface and heat dispersion. A die can include semiconductor devices that compose one or more processing devices or other circuitry. A tile can include semiconductor devices that compose one or more processing devices or other circuitry. For example, a physical package can include one or more dies, plastic or ceramic housing for the dies, and conductive contacts conductively coupled to a circuit board.

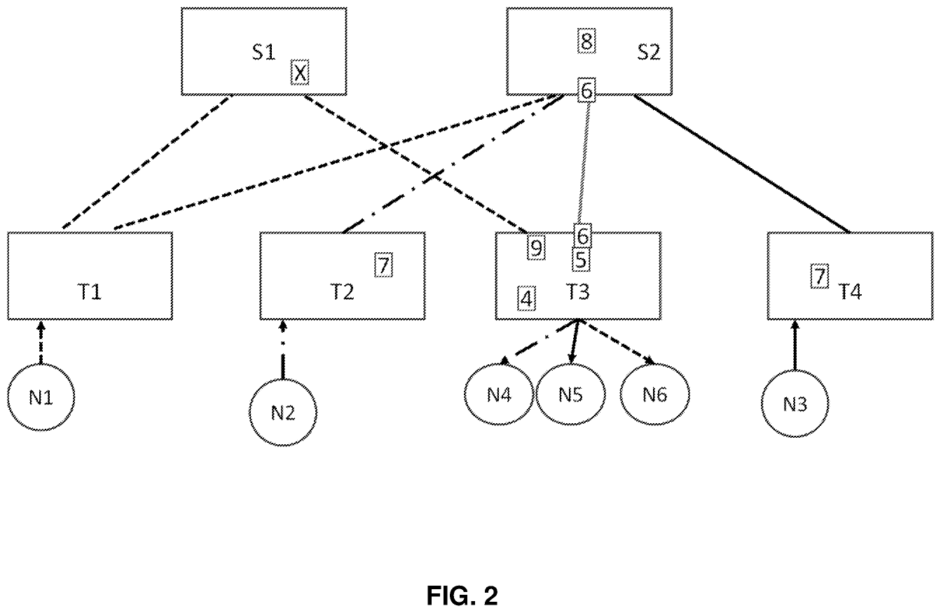

FIG. 2 depicts an example system and operation. In this example, network interface devices N1, N2, and N3 send packets to three different destination network interface devices N4, N5, and N6 via four ToR switches (T1, T2, T3 and T4) and two spine switches (S1 and S2). Network interface devices N1-N6 can be time synchronized as described herein.

In some examples, a leaf node switch (e.g., one or more of T1-T4) can insert a transmit time stamp into a packet at time of receipt of packets and utilize time synchronization with other endpoint sender NICs (N1 to N6) that could also insert time stamps.

In this example, because of packet spray, packets of different flows traverse switch S2 but packets of a flow destined to network interface device N6 also traverse switch S1. The numbers indicate the time stamp order, where a lower number represents an older time stamp value. Where packet 9 arrives at switch T3 sooner than packet 8, because packet 8 is older than packet 9, the arbiter in switch T3 egresses packet 8 before egressing packet 9. An arbiter in switch T3 selects an oldest packet received by different ingress ports for egress and blocks egress of packets from other ingress ports until other ingress ports receive the oldest packet at the head of its queue.

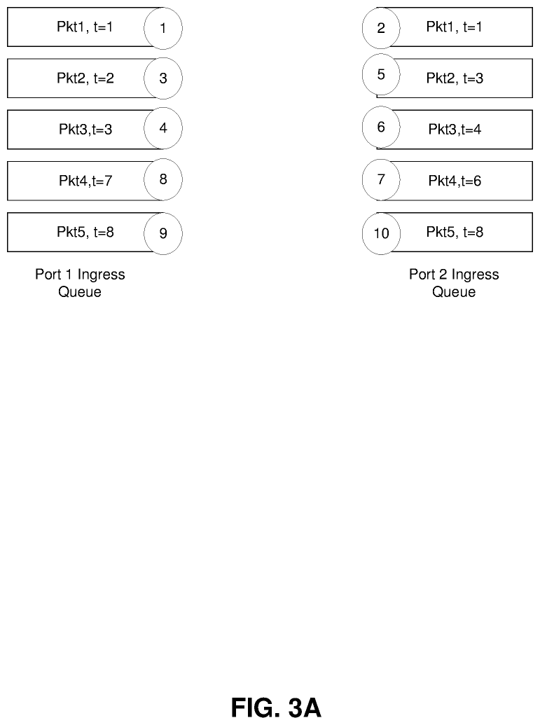

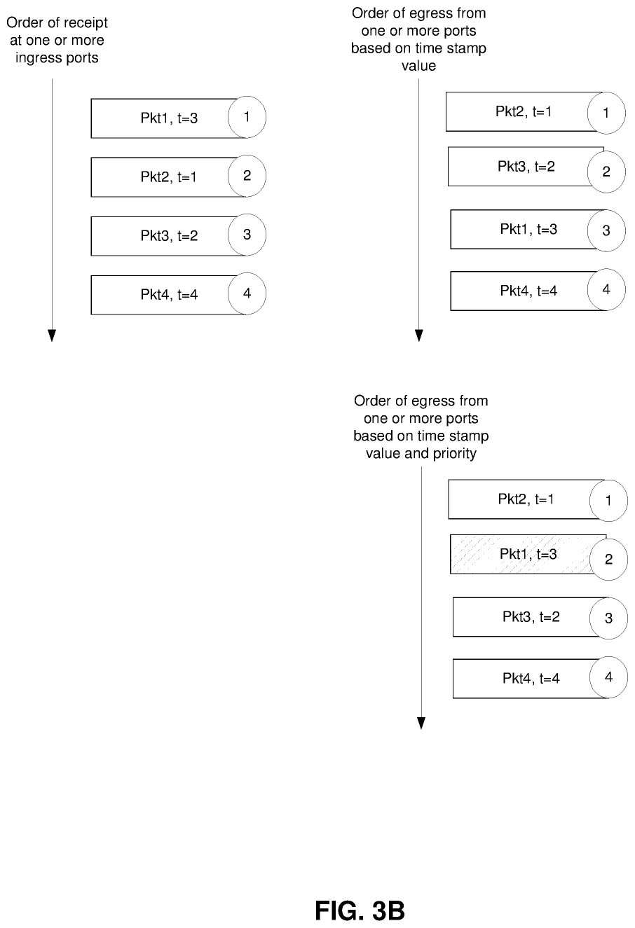

FIG. 3A illustrates an example of egress ordering from different ingress queues. For two ports of a switch that are active for ingress, a queue can be associated with an ingress port and store entries that indicate a packet number and the egress timestamp for the corresponding packet. In some examples, an egress scheduling order could be as follows. At (1), packet 1 (Pkt1) received at port 1 (Port1) having a time stamp value t=1 can be egressed. At (2), packet 1 (Pkt1) received at port 2 (Port2) having a time stamp value t=1 can be egressed. Note that Pkt1 received at Port 1 and Pkt1 received at Port 2 can be egressed at the same time or overlapping times by different egress ports. In this example, Pkt1 received at Port 1 can be a higher priority than Pkt1 received at Port 2 and Pkt1 received at Port 1 can be egressed prior to Pkt1 received at Port 2 despite having a same time stamp value as that of Pkt1 received at Port 1.

At (3), packet 2 (Pkt2) received at port 1 (Port1) having a time stamp value t=2 can be egressed. At (4), packet 3 (Pkt3) received at port 1 (Port1) having a time stamp value t=3 can be egressed. At (5), packet 2 (Pkt2) received at port 2 (Port2) having a time stamp value t=3 can be egressed on different egress ports. Note that Pkt3 received at Port 1 and Pkt2 received at Port 2 can be egressed at the same time or overlapping times by different egress ports. In this example, Pkt3 received at Port 1 can be a higher priority than Pkt2 received at Port 2 and Pkt3 received at Port 1 can be egressed prior to Pkt2 received at Port 2 despite having a same time stamp value as that of Pkt3 received at Port 1.

At (6), packet 3 (Pkt3) received at port 2 (Port2) having a time stamp value t=4 can be egressed. At (7), packet 4 (Pkt4) received at port 2 (Port2) having a time stamp value t=6 can be egressed. At (8), packet 4 (Pkt4) received at port 1 (Port1) having a time stamp value t=7 can be egressed.

At (9), packet 5 (Pkt5) received at port 1 (Port1) having a time stamp value t=8 can be egressed. At (10), packet 5 (Pkt5) received at port 2 (Port2) having a time stamp value t=8 can be egressed. Note that Pkt5 received at Port 1 and Pkt5 received at Port 2 can be egressed at the same time or overlapping times by different egress ports. In this example, Pkt5 received at Port 1 can be a higher priority than Pkt5 received at Port 2 and Pkt5 received at Port 1 can be egressed prior to Pkt5 received at Port 2 despite having a same time stamp value as that of Pkt5 received at Port 1.

FIG. 3B depicts an example of ingress of packets and egress ordering of packets. Packets can be received at one or more ingress ports in order of (1) Pkt1 with time stamp value t=3, (2) Pkt2 with time stamp value t=1, (3) Pkt3 with time stamp value t=2, and (4) Pkt4 with time stamp value t=4. Based on time stamp ordering in a manner described herein, a network interface device can egress packets from one or more ports in order of: (1) Pkt2 with time stamp value t=1, (2) Pkt3 with time stamp value t=2, (3) Pkt1 with time stamp value t=3, and (4) Pkt4 with time stamp value t=4.

Based on time stamp ordering and priority, where packet Pkt1 has a higher priority than packet Pkt3 but newer time stamp and packet Pkt1 has a same or lower priority than packet Pkt2, a network interface device can egress packets from one or more ports in order of: (1) Pkt2 with time stamp value t=1, (2) Pkt1 with time stamp value t=3, (3) Pkt3 with time stamp value t=2, and (4) Pkt4 with time stamp value t=4.

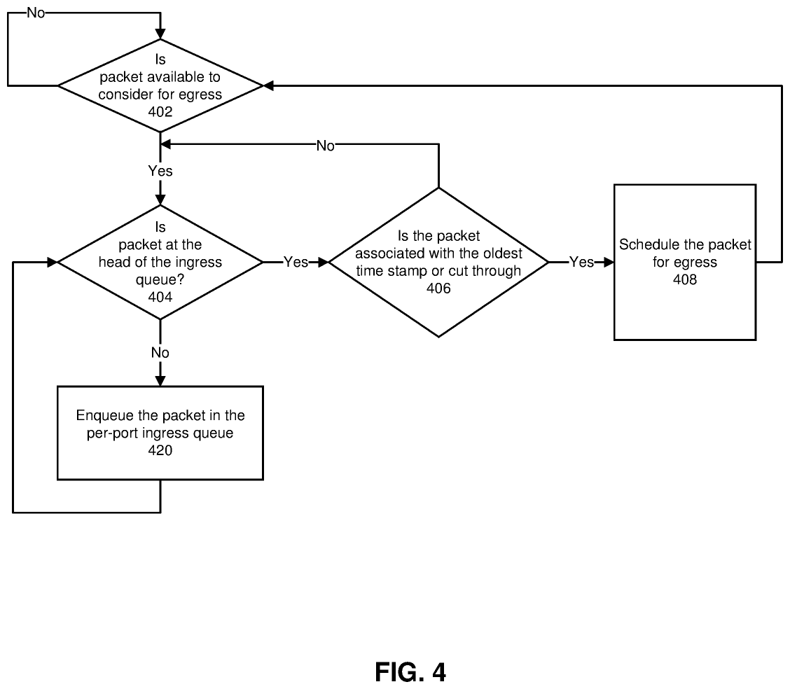

FIG. 4 depicts an example process. The process can be performed by a time stamp arbiter circuitry such as a packet processing circuitry in a switch or other network interface device. At 402, a determination can be made if a packet is available to egress. In some examples, a packet can be available to egress based on the packet arriving on a particular ingress port. In some examples, a packet can be available to egress based on the packet arriving on a particular ingress port and subject to cut-through mode where the arriving packet skips to a head of line of a queue. In some examples, a packet can be available to egress based on the packet arriving on a particular ingress port and is a highest priority packet. The per-port ingress queue can be associated with packets with egress timestamps that were received at a particular ingress port. The per-port ingress queue can be associated with a particular priority level (e.g., high, medium, low) of packets with egress timestamps received at a particular ingress port. Based on a packet being available to egress, the process can proceed to 404. Based on a packet not being available to egress, the process can repeat 402.

At 404, a determination can be made if the packet is at a head of a per-port ingress queue. For example, a head of a per-port ingress queue can be a packet that is next in line to be egressed based on first-in-first out ordering. Based on the packet being next in line to be egressed based on first-in-first out ordering, the process can proceed to 406. Based on the packet not being next in line to be egressed based on first-in-first out ordering, the process can proceed to 420.

At 406, a determination can be made if the packet is associated with an oldest time stamp among other packets in other per-port ingress queues or is subject to cut through. Based on the packet being associated with an oldest time stamp among other packets in other per-port ingress queues, is highest priority, or subject to cut through, the process can proceed to 408. Based on the packet not being associated with an oldest time stamp among other packets in other per-port ingress queues, not a highest priority packet, and not subject to cut through, the process can proceed to 404.

At 408, the packet can be dequeued and not associated with the per-port ingress queue and can be marked to be scheduled next for egress. For example, the packet can be associated with an available valid egress port for egress. A valid egress port can be available for use by a packet routing scheme. The process can return to 404.

At 420, the packet can be enqueued in a per-port ingress queue or remain enqueued in the per-port ingress queue. The process can return to 404.

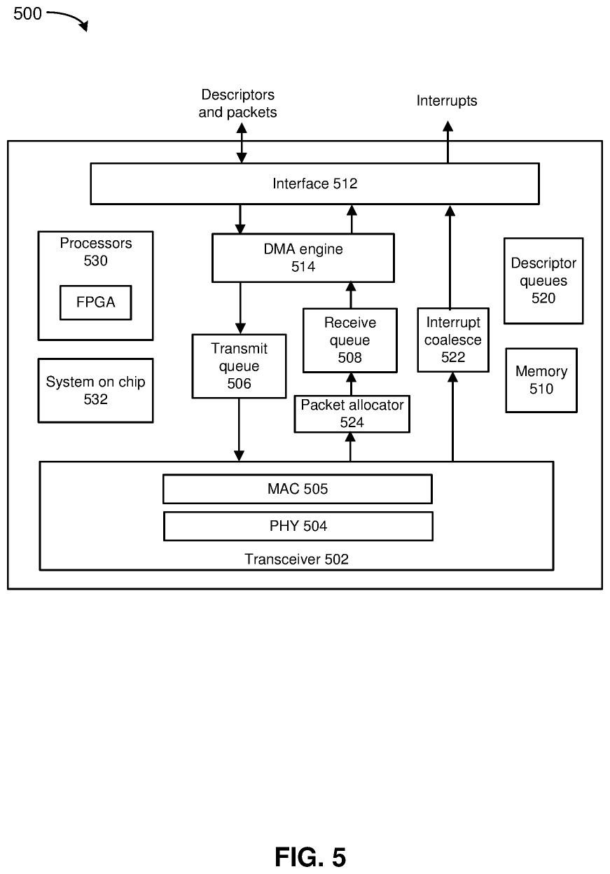

FIG. 5 depicts an example network interface device. In some examples, processors and/or FPGAs 530 can be configured to insert time stamps into packets prior to transmission or receive packets that are time ordered (and potentially perform re-ordering), as described herein. Network interface device can be configured as an endpoint receiver that is multi home and receives time ordered packets, potentially reorders packets, and coalesces packet contents before copying packet contents up to a host. Some examples of network interface 500 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 500 can include transceiver 502, processors 504, transmit queue 506, receive queue 508, memory 510, and interface 512, and DMA engine 514. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 504 and media access control (MAC) circuitry 505. PHY circuitry 504 can include encoding and decoding circuitry (not shown) to encode and decode data packets according to applicable physical layer specifications or standards. MAC circuitry 505 can be configured to perform MAC address filtering on received packets, process MAC headers of received packets by verifying data integrity, remove preambles and padding, and provide packet content for processing by higher layers. MAC circuitry 516 can be configured to assemble data to be transmitted into packets, that include destination and source addresses along with network control information and error detection hash values.

As described herein, PHY 504 and/or MAC 505 can be configured to insert time stamps into packets prior to transmission or egress packets according to time stamp values and priority level, as described herein.

Processors 530 can be one or more of: combination of: a processor, core, graphics processing unit (GPU), field programmable gate array (FPGA), application specific integrated circuit (ASIC), or other programmable hardware device that allow programming of network interface 500. For example, a “smart network interface” or SmartNIC can provide packet processing capabilities in the network interface using processors 530.

Processors 530 can include a programmable processing pipeline or offload circuitries that is programmable by P4, Software for Open Networking in the Cloud (SONIC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be utilized for packet processing or packet modification. Ternary content-addressable memory (TCAM) can be used for parallel match-action or look-up operations on packet header content.

Packet allocator 524 can provide distribution of received packets for processing by multiple CPUs or cores using receive side scaling (RSS). When packet allocator 524 uses RSS, packet allocator 524 can calculate a hash or make another determination based on contents of a received packet to determine which CPU or core is to process a packet.

Interrupt coalesce 522 can perform interrupt moderation whereby interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into a coalesced packet. Network interface 500 provides this coalesced packet to an application.

Direct memory access (DMA) engine 514 can copy a packet header, packet payload, and/or descriptor directly from host memory to the network interface or vice versa, instead of copying the packet to an intermediate buffer at the host and then using another copy operation from the intermediate buffer to the destination buffer.

In some examples, processors 530 can be configured to perform packet re-ordering to re-order packets according to time stamp values and/or packet sequence numbers prior to copying packets through interface 512 to a host system.

Memory 510 can be volatile and/or non-volatile memory device and can store any queue or instructions used to program network interface 500. Transmit traffic manager can schedule transmission of packets from transmit queue 506. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Interface 512 can provide an interface with host device (not depicted). For example, interface 512 can be compatible with or based at least in part on PCI, PCIe, PCI-x, Serial ATA, and/or USB (although other interconnection standards may be used), or proprietary variations thereof.

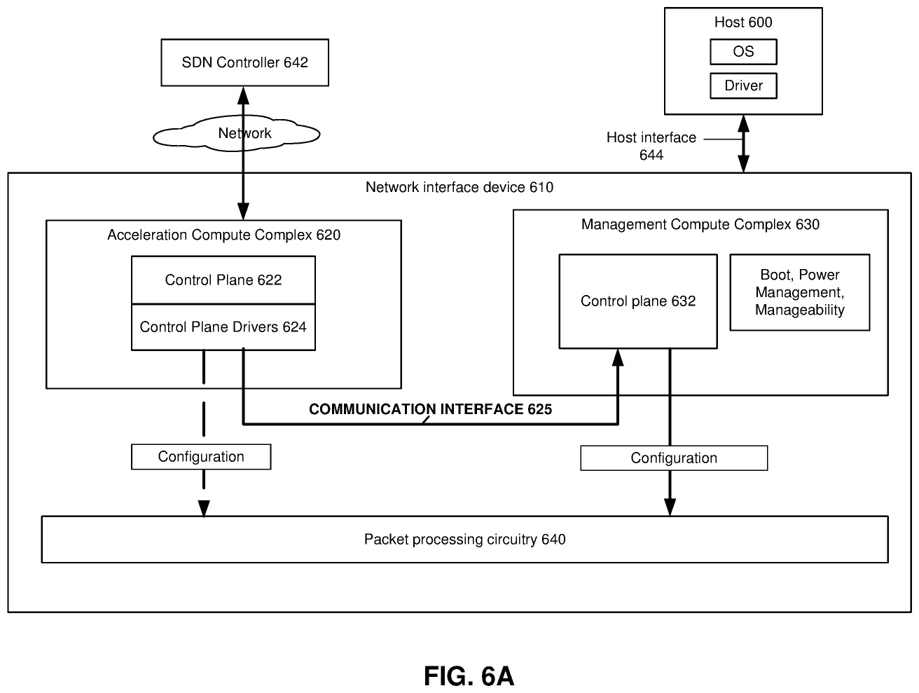

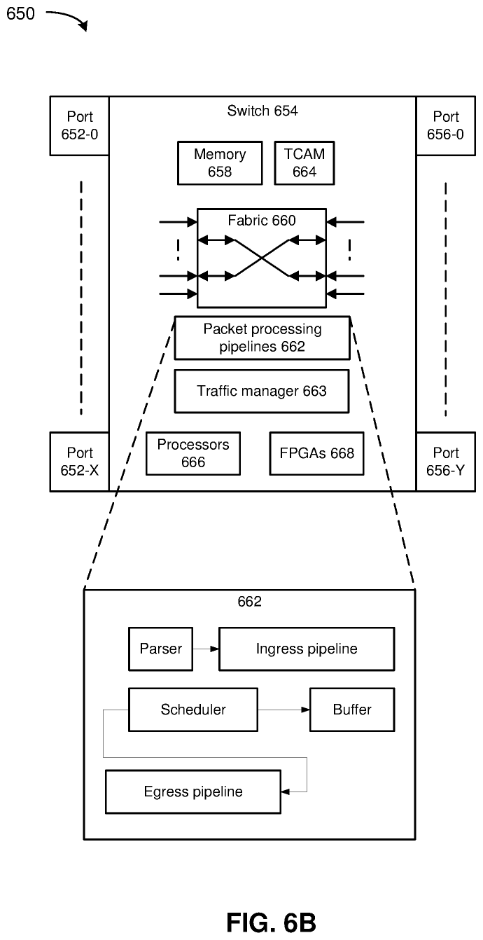

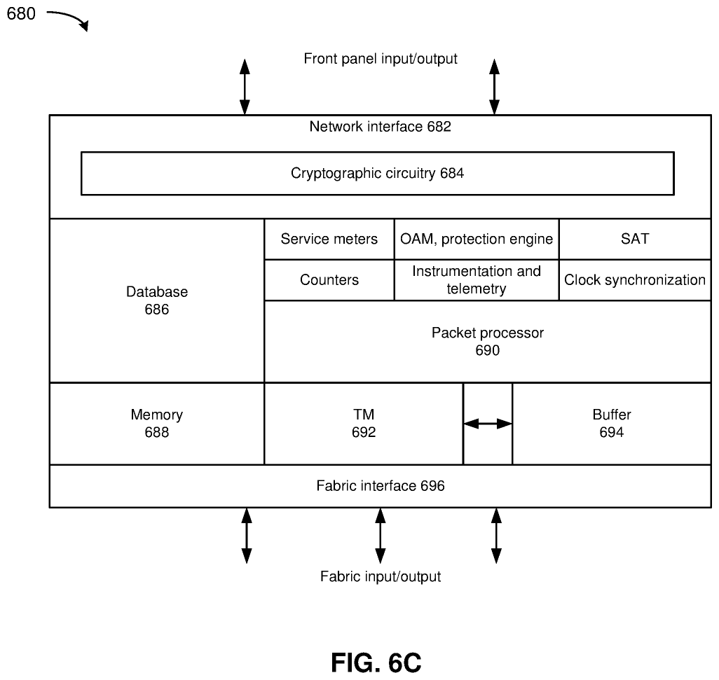

FIG. 6A depicts an example network interface device. Host 600 can include processors, memory devices, device interfaces, as well as other circuitry such as described herein. Processors of host 600 can execute software such as applications (e.g., microservices, virtual machine (VMs), microVMs, containers, processes, threads, or other virtualized execution environments), operating system (OS), and device drivers. An OS or device driver can configure network interface device or packet processing device 610 to utilize one or more control planes to communicate with software defined networking (SDN) controller 650 via a network to configure operation of the one or more control planes.

Packet processing device 610 can include multiple compute complexes, such as an Acceleration Compute Complex (ACC) 620 and Management Compute Complex (MCC) 630, as well as packet processing circuitry 640 and network interface technologies for communication with other devices via a network. ACC 620 can be implemented as one or more of: a microprocessor, processor, accelerator, field programmable gate array (FPGA), application specific integrated circuit (ASIC) or circuitry described at least with respect to herein. Similarly, MCC 630 can be implemented as one or more of: a microprocessor, processor, accelerator, field programmable gate array (FPGA), application specific integrated circuit (ASIC) or circuitry described herein. In some examples, ACC 620 and MCC 630 can be implemented as separate cores in a CPU, different cores in different CPUs, different processors in a same integrated circuit, different processors in different integrated circuit.

Packet processing device 610 can be implemented as one or more of: a microprocessor, processor, accelerator, field programmable gate array (FPGA), application specific integrated circuit (ASIC) or circuitry described herein. Packet processing pipeline circuitry 640 can process packets as directed or configured by one or more control planes executed by multiple compute complexes. In some examples, ACC 620 and MCC 630 can execute respective control planes 622 and 632.

Packet processing device 610, ACC 620, and/or MCC 630 can be configured to insert time stamps into packets prior to transmission or egress packets according to time stamp values and priority level, as described herein.

SDN controller 642 can upgrade or reconfigure software executing on ACC 620 (e.g., control plane 622 and/or control plane 632) through contents of packets received through packet processing device 610. In some examples, ACC 620 can execute control plane operating system (OS) (e.g., Linux) and/or a control plane application 622 (e.g., user space or kernel modules) used by SDN controller 642 to configure operation of packet processing pipeline 640. Control plane application 622 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 642 can communicate with ACC 620 using a remote procedure call (RPC) such as Google remote procedure call (gRPC) or other service and ACC 620 can convert the request to target specific protocol buffer (protobuf) request to MCC 630. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 642 can provide packet processing rules for performance by ACC 620. For example, ACC 620 can program table rules (e.g., header field match and corresponding action) applied by packet processing pipeline circuitry 640 based on change in policy and changes in VMs, containers, microservices, applications, or other processes. ACC 620 can be configured to provide network policy as flow cache rules into a table to configure operation of packet processing pipeline 640. For example, the ACC-executed control plane application 622 can configure rule tables applied by packet processing pipeline circuitry 640 with rules to define a traffic destination based on packet type and content. ACC 620 can program table rules (e.g., match-action) into memory accessible to packet processing pipeline circuitry 640 based on change in policy and changes in VMs.

For example, ACC 620 can execute a virtual switch such as vSwitch or Open vSwitch (OVS), Stratum, or Vector Packet Processing (VPP) that provides communications between virtual machines executed by host 600 or with other devices connected to a network. For example, ACC 620 can configure packet processing pipeline circuitry 640 as to which VM is to receive traffic and what kind of traffic a VM can transmit. For example, packet processing pipeline circuitry 640 can execute a virtual switch such as vSwitch or Open vSwitch that provides communications between virtual machines executed by host 600 and packet processing device 610.

MCC 630 can execute a host management control plane, global resource manager, and perform hardware registers configuration. Control plane 632 executed by MCC 630 can perform provisioning and configuration of packet processing circuitry 640. For example, a VM executing on host 600 can utilize packet processing device 610 to receive or transmit packet traffic. MCC 630 can execute boot, power, management, and manageability software (SW) or firmware (FW) code to boot and initialize the packet processing device 610, manage the device power consumption, provide connectivity to Baseboard Management Controller (BMC), and other operations.

One or both control planes of ACC 620 and MCC 630 can define traffic routing table content and network topology applied by packet processing circuitry 640 to select a path of a packet in a network to a next hop or to a destination network-connected device. For example, a VM executing on host 600 can utilize packet processing device 610 to receive or transmit packet traffic.

ACC 620 can execute control plane drivers to communicate with MCC 630. At least to provide a configuration and provisioning interface between control planes 622 and 632, communication interface 625 can provide control-plane-to-control plane communications. Control plane 632 can perform a gatekeeper operation for configuration of shared resources. For example, via communication interface 625, ACC control plane 622 can communicate with control plane 632 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 625 can be utilized by a negotiation protocol and configuration protocol running between ACC control plane 622 and MCC control plane 632. Communication interface 625 can include a general purpose mailbox for different operations performed by packet processing circuitry 640. Examples of operations of packet processing circuitry 640 include issuance of non-volatile memory express (NVMe) reads or writes, issuance of Non-volatile Memory Express over Fabrics (NVMe-oFTM) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 625 can include one or more mailboxes accessible as registers or memory addresses. For communications from control plane 622 to control plane 632, communications can be written to the one or more mailboxes by control plane drivers 624. For communications from control plane 632 to control plane 622, communications can be written to the one or more mailboxes. Communications written to mailboxes can include descriptors which include message opcode, message error, message parameters, and other information. Communications written to mailboxes can include defined format messages that convey data.

Communication interface 625 can provide communications based on writes or reads to particular memory addresses (e.g., dynamic random access memory (DRAM)), registers, other mailbox that is written-to and read-from to pass commands and data. To provide for secure communications between control planes 622 and 632, registers and memory addresses (and memory address translations) for communications can be available only to be written to or read from by control planes 622 and 632 or cloud service provider (CSP) software executing on ACC 620 and device vendor software, embedded software, or firmware executing on MCC 630. Communication interface 625 can support communications between multiple different compute complexes such as from host 600 to MCC 630, host 600 to ACC 620, MCC 630 to ACC 620, or others.

Packet processing circuitry 640 can be implemented using one or more of: application specific integrated circuit (ASIC), field programmable gate array (FPGA), processors executing software, or other circuitry. Control plane 622 and/or 632 can configure packet processing pipeline circuitry 640 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 620 or MCC 630. In some examples, a P4 program can be compiled and provided to MCC 630 to configure packet processing circuitry 640 to egress packets according to time stamp values and priority level, as described herein.

FIG. 6B depicts an example switch. Various examples can be used in or with the switch to insert time stamps into packets prior to transmission or egress packets according to time stamp values and priority level, as described herein. Switch 654 can route packets or frames of any format or in accordance with any specification from any port 652-0 to 652-X to any of ports 656-0 to 656-Y (or vice versa). One or more of ports 652-0 to 652-X can be connected to a network of one or more interconnected devices. Similarly, any of ports 656-0 to 656-Y can be connected to a network of one or more interconnected devices.

In some examples, switch fabric 660 can provide routing of packets from one or more ingress ports for processing prior to egress from switch 654. Switch fabric 660 can be implemented as one or more multi-hop topologies, where example topologies include torus, butterflies, buffered multi-stage, etc., or shared memory switch fabric (SMSF), among other implementations. SMSF can be any switch fabric connected to ingress ports and egress ports in the switch, where ingress subsystems write (store) packet segments into the fabric's memory, while the egress subsystems read (fetch) packet segments from the fabric's memory.

Memory 658 can be configured to store packets received at ports prior to egress from one or more ports. Packet processing pipelines 662 can include ingress and egress packet processing circuitry to respectively process ingressed packets and packets to be egressed.

In some examples, packet processing pipelines 662 can include a parser, an ingress pipeline, a buffer, scheduler, and egress pipelines. In some examples, packet processing pipelines 662 can perform operations of traffic manager 663.

Packet processing pipelines 662 can determine which port to transfer packets or frames to using a table that maps packet characteristics with an associated output port. Packet processing pipelines 662 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry (e.g., forwarding decision based on a packet header content). Packet processing pipelines 662 can implement access control list (ACL) or packet drops due to queue overflow. Packet processing pipelines 662 can be configured to insert time stamps into packets prior to transmission or egress packets according to time stamp values and priority level, as described herein. Configuration of operation of packet processing pipelines 662, including its data plane, can be programmed using P4, C, Python, Broadcom Network Programming Language (NPL), or x86 compatible executable binaries or other executable binaries. Processors 666 and FPGAs 668 can be utilized for packet processing or modification.

Traffic manager 663 can perform hierarchical scheduling and transmit rate shaping and metering of packet transmissions from one or more packet queues. Traffic manager 663 can perform congestion management such as flow control, congestion notification message (CNM) generation and reception, priority flow control (PFC), and others. Circuitry and software of a network interface described herein can be utilized by switch 650, including a MAC and SerDes.

FIG. 6C depicts an example switch. Various examples can be used in or with the switch to egress packets according to time stamp values and priority level, as described herein. Switch 680 can include a network interface 682 that can provide an Ethernet consistent interface. Network interface 682 can support 25 GbE, 50 GbE, 100 GbE, 200 GbE, 400 GbE Ethernet port interfaces. Cryptographic circuitry 684 can perform at least Media Access Control security (MACsec) or Internet Protocol Security (IPSec) decryption for received packets or encryption for packets to be transmitted.

Various circuitry can perform one or more of: service metering, packet counting, operations, administration, and management (OAM), protection engine, instrumentation and telemetry, and clock synchronization (e.g., based on IEEE 1588).

Database 686 can store a device's profile to configure operations of switch 680. Memory 688 can include High Bandwidth Memory (HBM) for packet buffering. Packet processor 690 can perform one or more of: decision of next hop in connection with packet forwarding, packet counting, access-list operations, bridging, routing, Multiprotocol Label Switching (MPLS), virtual private LAN service (VPLS), L2VPNs, L3VPNs, OAM, Data Center Tunneling Encapsulations (e.g., VXLAN and NV-GRE), or others. Packet processor 690 can include one or more FPGAs. Buffer 694 can store one or more packets. Traffic manager (TM) 692 can provide per-subscriber bandwidth guarantees in accordance with service level agreements (SLAs) as well as performing hierarchical quality of service (QOS). Fabric interface 696 can include a serializer/de-serializer (SerDes) and provide an interface to a switch fabric.

Operations of components of switches of examples of devices described herein can be combined and components of the switches described herein can be included in other examples of switches of examples described herein. For example, components of examples of switches described herein can be implemented in a switch system on chip (SoC) that includes at least one interface to other circuitry in a switch system. A switch SoC can be coupled to other devices in a switch system such as ingress or egress ports, memory devices, or host interface circuitry.

FIG. 7 depicts a system. In some examples, circuitry of system 700 can configure network interface device 750 to insert time stamps into packets prior to transmission or egress packets according to time stamp values and priority level, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 732 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 732, a system administrator, and/or orchestrator can enable or disable network interface 750 to insert time stamps into packets prior to transmission or egress packets according to time stamp values and priority level, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, packet processing device or network interface device 750 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 700 includes one or more input/output (I/O) interface(s) 760. I/O interface 760 can include one or more interface components through which a user interacts with system 700. Peripheral interface 770 can include any hardware interface not specifically mentioned above. Peripherals refer generally to devices that connect dependently to system 700.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 700 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

In an example, system 700 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: a network interface device comprising: an interface to a port; and a circuitry configured to: receive a first packet that comprises a time stamp associated with a prior or originating transmission of the first packet by a transmitter network interface device; enqueue an entry for the first packet in a queue; and dequeue the entry based at least in part on the time stamp.

Example 2 includes one or more examples, wherein the circuitry is to egress the first packet associated with the queue and a second packet associated with a second queue based on time stamps associated with the first packet and the second packet, wherein the first packet and the second packet are received by the network interface device from multiple network interface devices.

Example 3 includes one or more examples, wherein the first packet and the second packet are associated with a same flow.

Example 4 includes one or more examples, wherein the network interface device comprises a switch chip.

Example 5 includes one or more examples, wherein the circuitry is to egress a second packet before the packet based on a priority level of the second packet.

Example 6 includes one or more examples, wherein the circuitry is to egress the packet and the second packet by multiple ports using a multipath protocol.

Example 7 includes one or more examples, wherein the network interface device is to receive the packet and the second packet in multiple ingress ports and wherein the multiple network interface devices are time synchronized.

Example 8 includes one or more examples, wherein the network interface device is to receive the packet and the second packet in a single ingress port from the multiple network interface devices and wherein the multiple network interface devices are time synchronized.

Example 9 includes one or more examples, wherein the circuitry is to store packets with associated time stamps into a first queue and is to store packets with no associated time stamps into a second queue.

Example 10 includes one or more examples, and includes at least one ingress port and at least one egress port, wherein the at least one ingress port and the at least one egress port are coupled to the interface.

Example 11 includes one or more examples, and includes at least one non-transitory computer-readable medium comprising instructions stored thereon, that if executed by a switch circuitry, cause the switch circuitry to: egress a packet associated with a queue and a second packet associated with a second queue based on time stamps associated with the packet and the second packet, wherein the packet and the second packet are received from multiple network interface devices and wherein the time stamps associated with the packet and the second packet are indicative of transmission of the packet and the second packet.

Example 12 includes one or more examples, and includes instructions stored thereon, that if executed by a switch circuitry, cause the switch circuitry to: egress the packet associated with the queue and a second packet associated with a second queue based on time stamps associated with the packet and the second packet, wherein the packet and the second packet are received by the switch circuitry from multiple network interface devices.

Example 13 includes one or more examples, wherein the packet and the second packet are associated with a same flow.

Example 14 includes one or more examples, and includes instructions stored thereon, that if executed by a switch circuitry, cause the switch circuitry to: egress a second packet before the packet based on a priority level of the second packet.

Example 15 includes one or more examples, and includes instructions stored thereon, that if executed by a switch circuitry, cause the switch circuitry to: egress the packet and the second packet by multiple ports using a multipath protocol.

Example 16 includes one or more examples, and includes a method comprising: a switch performing: egressing a packet associated with a queue and a second packet associated with a second queue based on time stamps associated with the packet and the second packet, wherein the packet and the second packet are received by the switch from multiple network interface devices.

Example 17 includes one or more examples, and includes egressing a second packet before the packet based on a priority level of the second packet.

Example 18 includes one or more examples, and includes egressing the packet and the second packet by multiple ports using a multipath protocol.

Example 19 includes one or more examples, and includes receiving the packet and the second packet in multiple ingress ports and wherein the multiple network interface devices are time synchronized.

Example 20 includes one or more examples, and includes storing packets with associated time stamps into a first queue and storing packets with no associated time stamps into a second queue.

Example 21 includes one or more examples, and includes a network interface device physical layer interface (PHY) or media access control (MAC) circuitry inserting a time stamp value into a packet.

Example 22 includes one or more examples, and includes a switch inserting a time stamp value into a packet.

Example 23 includes performing time synchronization of network interface devices that insert time stamps into packets based on one or more of Institute of Electrical and Electronics Engineers (IEEE) 1588 Precision Time Protocol (PTP), Peripheral Component Interconnect Express (PCIe) Precision Time Measurement (PTM), a global positioning system (GPS) signal, satellite (e.g., Global Navigation Satellite Systems (GNSS)), or other technologies.

1. An apparatus comprising:
a network interface device comprising:
an interface to a port; and
a circuitry configured to:
receive a first packet that comprises a time stamp associated with a prior or originating transmission of the first packet by a transmitter network interface device;
enqueue an entry for the first packet in a queue; and
dequeue the entry based at least in part on the time stamp.

2. The apparatus of claim 1, wherein the circuitry is to egress the first packet associated with the queue and a second packet associated with a second queue based on time stamps associated with the first packet and the second packet, wherein the first packet and the second packet are received by the network interface device from multiple network interface devices.

3. The apparatus of claim 2, wherein the first packet and the second packet are associated with a same flow.

4. The apparatus of claim 1, wherein the network interface device comprises a switch chip.

5. The apparatus of claim 1, wherein the circuitry is to egress a second packet before the packet based on a priority level of the second packet.

6. The apparatus of claim 2, wherein the circuitry is to egress the packet and the second packet by multiple ports using a multipath protocol.

7. The apparatus of claim 2, wherein the network interface device is to receive the packet and the second packet in multiple ingress ports and wherein the multiple network interface devices are time synchronized.

8. The apparatus of claim 2, wherein the network interface device is to receive the packet and the second packet in a single ingress port from the multiple network interface devices and wherein the multiple network interface devices are time synchronized.

9. The apparatus of claim 1, wherein the circuitry is to store packets with associated time stamps into a first queue and is to store packets with no associated time stamps into a second queue.

10. The apparatus of claim 1, comprising at least one ingress port and at least one egress port, wherein the at least one ingress port and the at least one egress port are coupled to the interface.

11. At least one non-transitory computer-readable medium comprising instructions stored thereon, that if executed by a switch circuitry, cause the switch circuitry to:
egress a packet associated with a queue and a second packet associated with a second queue based on time stamps associated with the packet and the second packet, wherein the packet and the second packet are received from multiple network interface devices and wherein the time stamps associated with the packet and the second packet are indicative of transmission of the packet and the second packet.

12. The at least one non-transitory computer-readable medium of claim 11, comprising instructions stored thereon, that if executed by a switch circuitry, cause the switch circuitry to:
egress the packet associated with the queue and a second packet associated with a second queue based on time stamps associated with the packet and the second packet, wherein the packet and the second packet are received by the switch circuitry from multiple network interface devices.

13. The at least one non-transitory computer-readable medium of claim 12, wherein the packet and the second packet are associated with a same flow.

14. The at least one non-transitory computer-readable medium of claim 11, comprising instructions stored thereon, that if executed by a switch circuitry, cause the switch circuitry to:
egress a second packet before the packet based on a priority level of the second packet.

15. The at least one non-transitory computer-readable medium of claim 12, comprising instructions stored thereon, that if executed by a switch circuitry, cause the switch circuitry to:
egress the packet and the second packet by multiple ports using a multipath protocol.

16. A method comprising:
a switch performing:
egressing a packet associated with a queue and a second packet associated with a second queue based on time stamps associated with the packet and the second packet, wherein the packet and the second packet are received by the switch from multiple network interface devices.

17. The method of claim 16, comprising:
egressing a second packet before the packet based on a priority level of the second packet.

18. The method of claim 17, comprising:
egressing the packet and the second packet by multiple ports using a multipath protocol.

19. The method of claim 17, comprising:
receiving the packet and the second packet in multiple ingress ports and wherein the multiple network interface devices are time synchronized.

20. The method of claim 17, comprising:
storing packets with associated time stamps into a first queue and
storing packets with no associated time stamps into a second queue.
